(19) United States
(12) Patent Application Publication
(10) Pub. No.: US 2026/0073594 A1
(43) Pub. Date: Mar. 12, 2026

(54) IMAGE AUGMENTATION DEVICE AND METHOD

(71) Applicants: HON HAI PRECISION INDUSTRY CO., LTD., New Taipei City (TW); Foxconn Technology Group Co., Ltd., Guangdong Province (CN)

(72) Inventors: Yung-Hui LI, New Taipei City (TW); Nien-Yi JAN, New Taipei City (TW); Kai-Lin YANG, New Taipei City (TW); Yi-Rong LIN, New Taipei City (TW); Yudong MAO, New Taipei City (TW); Xing TIAN, New Taipei City (TW); Yibing LIU, New Taipei City (TW)

(21) Appl. No.: 19/319,759

(22) Filed: Sep. 5, 2025

Related U.S. Application Data
(60) Provisional application No. 63/693,714, filed on Sep. 12, 2024.

(51) Int. Cl. G06T 11/60; G06T 5/60; G06T 5/70

(52) U.S. Cl. CPC G06T 11/60; G06T 5/60; G06T 5/70; G06T 2207/20084

(57) ABSTRACT

An image augmentation device and method are provided. The image augmentation device inputs a noise image corresponding to an original image and semantic information and a text vector corresponding to the original image into a diffusion model to generate a generated image, and the generated image includes a partial contour of the original image. The image augmentation device composites the generated image and a plurality of guide images to generate an augmented image.

### CROSS-REFERENCE TO RELATED APPLICATION

This application claims priority to U.S. Provisional Application Ser. No. 63/693,714, filed Sep. 12, 2024, which is herein incorporated by reference in its entirety.

### BACKGROUND

### Technical Field

The present disclosure relates to an image augmentation device and method. Specifically, the present disclosure relates to an image augmentation device and method that can accurately augment image content.

### Description of Related Art

In recent years, to increase the diversity of training data for an artificial intelligence model (for example, an image classification model and an image detection model), various technologies and applications for image data augmentation using generative models have been proposed.

In a conventional technology, generally, a text prompt is input into the generative model, so that the generative model generates content corresponding to the text prompt in a generated image.

However, in such a case, image augmentation is performed on the generated image only by inputting the text prompt into the generative model. This process has poor controllability and may cause instability in a generation result.

For example, the generative model cannot accurately understand which area in an image belongs to which object category, resulting in generation of inaccurate content (for example, a wrong object is changed, and an object with the wrong color or texture is generated). If the generated image is further used as training data for another artificial intelligence model, the generalization and accuracy of the artificial intelligence model will be affected.

In view of this, how to provide an image augmentation device and method that can accurately augment image content is a goal that the industry urgently needs to work hard on.

### SUMMARY

An objective of the present disclosure is to provide an image augmentation device. The image augmentation device comprises a storage and a processor. The storage is configured to store a diffusion model. The processor is electrically connected to the storage. The processor inputs a noise image corresponding to an original image and semantic information and a text vector corresponding to the original image into the diffusion model to generate a generated image, wherein the generated image comprises a partial contour of the original image, and the semantic information comprises a plurality of semantic categories and a plurality of semantic ranges corresponding to the semantic categories The processor composites the generated image and a plurality of guide images to generate an augmented image, wherein the guide images are generated by segmenting the original image based on the semantic ranges.

Another objective of the present disclosure is to provide an image augmentation method. The image augmentation method is applied to an electronic device. The image augmentation method comprises the following steps: inputting a noise image corresponding to an original image and semantic information and a text vector corresponding to the original image into a diffusion model to generate a generated image, wherein the generated image comprises a partial contour of the original image, and the semantic information comprises a plurality of semantic categories and a plurality of semantic ranges corresponding to the semantic categories; and compositing the generated image and a plurality of guide images to generate an augmented image, wherein the guide images are generated by segmenting the original image based on the semantic ranges.

According to the technologies (comprising at least the image augmentation device and method) provided in the present disclosure, a noise image corresponding to an original image and semantic information and a text vector corresponding to the original image are input into a diffusion model to generate a generated image, wherein the generated image comprises a partial contour of the original image. Then, in the present disclosure, the generated image and a plurality of guide images are composited to generate an augmented image. Because the semantic information is used as the attention constraint in the diffusion model in the present disclosure, the technologies provided in the present disclosure can accurately augment content corresponding to different semantic categories in an image.

The following describes the detailed technologies and embodiments of the present disclosure with reference to the drawings, so that persons having ordinary skill in the art to which the present disclosure belongs can understand the technical features of the claimed invention.

### BRIEF DESCRIPTION OF THE DRAWINGS

FIG. 1 is a schematic diagram of an architecture of an image augmentation device of a first embodiment;

FIG. 2 is a schematic diagram of an image augmentation process of a first embodiment;

FIG. 3 is a schematic diagram of an attention operation process of a first embodiment;

FIG. 4A is a schematic diagram of an original image of some embodiments;

FIG. 4B is a schematic diagram of a generated image of some embodiments;

FIG. 5 is a schematic diagram of a guided filtering process of some embodiments; and

FIG. 6 is a flowchart of an image augmentation method of a second embodiment.

### DETAILED DESCRIPTION

An image augmentation device and method provided in the present disclosure are explained below by using embodiments. However, these embodiments are not intended to limit the present disclosure to be implemented in any environment, application, or manner described in these embodiments. Therefore, the description of the embodiments is only for an objective of illustrating the present disclosure, and is not intended to limit the scope of the present disclosure. It should be understood that in the following embodiments and drawings, components that are not directly related to the present disclosure are omitted and not shown, and the size of each component and the size ratio between components are only exemplary and are not intended to limit the scope of the present disclosure.

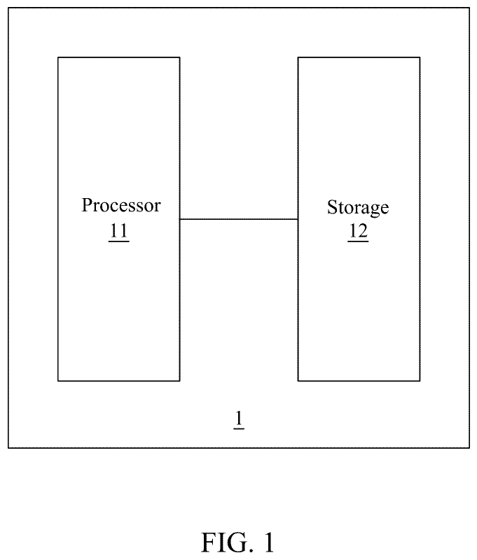

A first embodiment of the present disclosure is an image augmentation device, and a schematic diagram thereof is FIG. 1. As shown in FIG. 1, the image augmentation device 1 includes a processor 11 and a storage 12. The processor 11 is electrically connected to the storage 12.

It should be noted that the processor 11 may be any processing unit, a central processing unit (CPU), a microprocessor, or another computing device known to persons having ordinary skill in the art to which the case belongs. The storage 12 may be a memory, a universal serial bus (USB) disk, a hard disk, optical disk, a flash disk, or any other storage medium or circuit as known to persons having ordinary skill in the art to which the case belongs and having the same function.

In the present disclosure, a noise image, semantic information, and a text vector are input to a diffusion model to generate a generated image, and the generated image and a plurality of guide images are composited to generate an augmented image. Implementation details related to the present disclosure are described in detail in the following paragraphs.

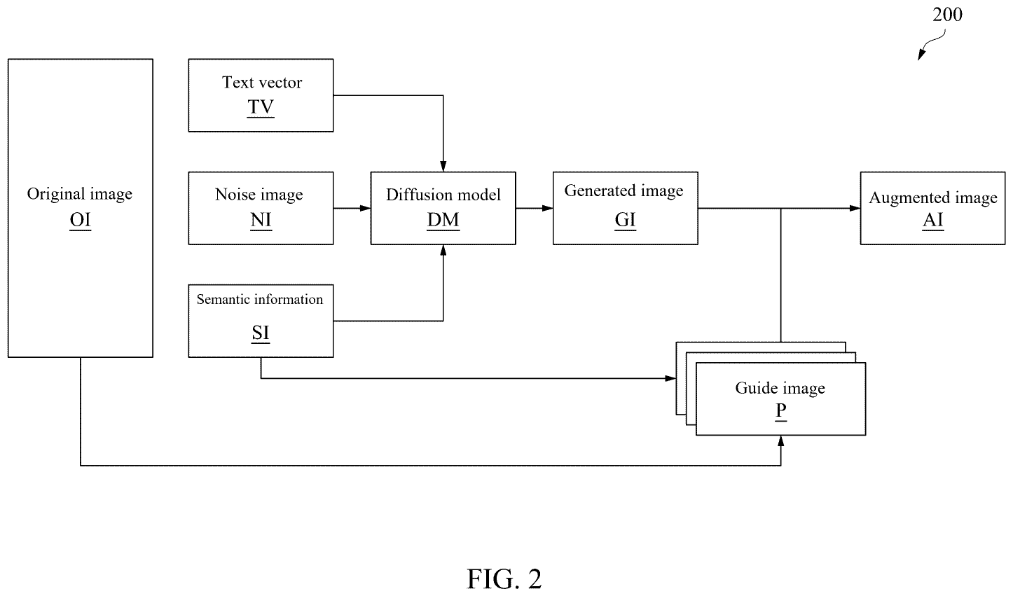

In the first embodiment, for ease of understanding, refer to a schematic diagram 200 of an image augmentation process in FIG. 2. As shown in the schematic diagram 200 of an image augmentation process, first, the processor 11 inputs a noise image NI corresponding to an original image OI and semantic information SI and a text vector TV corresponding to the original image OI into a diffusion model DM to generate a generated image GI. The diffusion model DM is stored in the storage 12. It should be noted that the diffusion model DM is any diffusion model (for example, a latent diffusion model) that may remove image noises.

It should be noted that the image augmentation device 1 may further include a transceiver interface, and the transceiver interface is configured to receive the original image OI. The transceiver interface is an interface capable of receiving and transmitting data or another interface capable of receiving and transmitting data known to persons having ordinary skill in the art to which the case belongs. The transceiver interface may receive data from sources such as external devices, external web pages, external applications.

It should be noted that a generation manner of the semantic information SI may be determined based on a source of the original image OI. For example, if the original image OI is provided by autonomous vehicle simulation software (for example, CARLA), the semantic information SI is also provided by the autonomous vehicle simulation software. For another example, if the original image OI is provided by an autonomous vehicle data set (for example, nuScenes, Waymo Dataset, and KITTI), the semantic information SI is also provided by the autonomous vehicle data set. For still another example, if the original image OI is recorded by a user using an image extractor, the semantic information SI may be generated by performing object segmentation on the original image OI based on an image segmentation model (for example, SAM, U-Net, and DeepLab).

In addition, the semantic information SI includes a plurality of semantic categories and a plurality of semantic ranges corresponding to the semantic categories. It should be noted that the semantic ranges are used to represent pixel ranges of objects of different semantic categories in an image. Each of the semantic ranges may be a matrix, and the dimension of the matrix is the same as the dimension of the image (for example, both are 256*256 two-dimensional matrices).

For example, a semantic category corresponding to an image is “vehicle”, and a matrix of a semantic range corresponding to the semantic category includes 0 and 1. A value being 0 in the matrix represents that the area does not belong to “vehicle”, and a value being 1 in the matrix represents that the area belongs to “vehicle”.

Finally, the processor 11 removes a noise from the noise image NI based on the diffusion model DM to generate the generated image GI, and the generated image GI includes a partial contour of the original image OI. For example, the partial contour may indicate a boundary of pixel ranges described by the semantic ranges. For another example, the partial contour may be an object contour of an object included in the original image OI (for example, a vehicle contour and a road contour).

It should be noted that content included in the generated image GI corresponds to the original image OI. For example, the original image OI includes a vehicle, the generated image GI also includes a vehicle, and the vehicle included in the generated image GI and the vehicle included in the original image OI have similar contours (that is, the generated image GI includes a partial contour of the original image OI), but the two have different colors or textures.

Specifically, the processor 11 inputs a noise image NI corresponding to an original image OI and semantic information SI and a text vector TV corresponding to the original image OI into the diffusion model DM to generate a generated image GI, wherein the generated image GI includes a partial contour of the original image OI, and the semantic information SI includes a plurality of semantic categories and a plurality of semantic ranges corresponding to the semantic categories.

In some embodiments, the processor 11 performs a noise addition operation on the original image OI to generate the noise image NI corresponding to the original image OI. For example, the processor 11 may perform the noise addition operation on the original image OI by using a model (for example, DDIM Reverse) calculating a potential noise in data.

Specifically, the processor 11 performs the noise addition operation on the original image OI to generate the noise image NI corresponding to the original image OI.

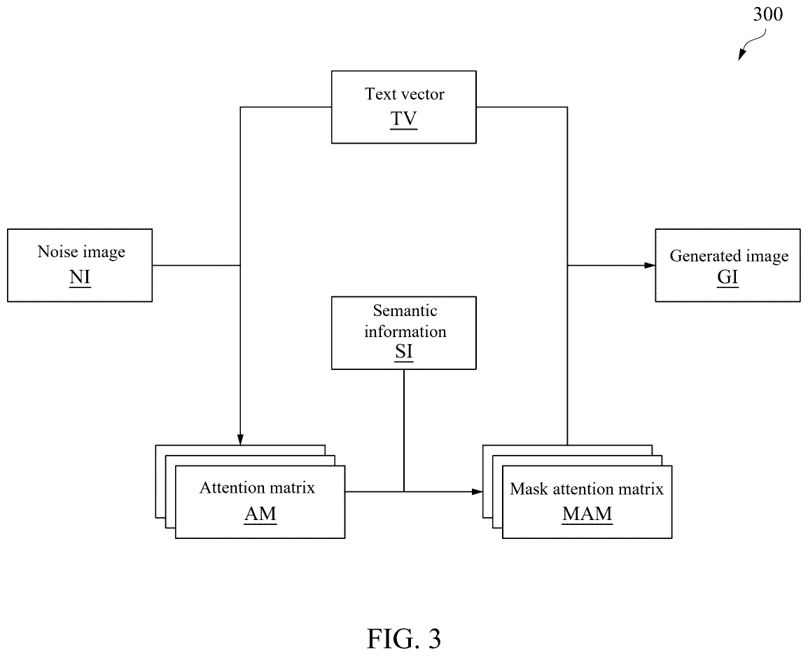

In some embodiments, the processor 11 performs a diffusion operation by using the diffusion model DM, and the diffusion operation includes an attention operation. For ease of understanding, refer to a schematic diagram 300 of an attention operation process in FIG. 3. As shown in the schematic diagram 300 of an attention operation process, first, the processor 11 multiplies a matrix of the noise image NI with the text vector TV to generate a plurality of attention matrices AM, and the attention matrices AM correspond to the semantic categories.

Then, the processor 11 multiplies the attention matrices AM corresponding to the semantic categories with matrices of the semantic ranges in the semantic information SI to generate a plurality of mask attention matrices MAM corresponding to the semantic categories. For example, the semantic categories include three categories: a vehicle, a road, and a sky, the attention matrices AM include attention matrices corresponding to the vehicle, the road, and the sky, respectively, and the mask attention matrices MAM also include mask attention matrices corresponding to the vehicle, the roads, and the sky, respectively.

Finally, the processor 11 multiplies the mask attention matrices MAM and the text vector TV to generate the generated image GI. It should be noted that the mask attention matrices MAM may be first multiplied by a sigmoid function to transform values in the matrices, and then multiplied by the text vector TV.

In addition, the diffusion model DM performs the diffusion operation, which may be implemented by a plurality of cross-attention models included in the diffusion model DM. For example, the diffusion model DM includes a first cross-attention model and a second cross-attention model, and the first cross-attention model is connected in series with the second cross-attention model. The noise image NI that is input into the diffusion model DM undergoes an attention operation for the first time by the first cross-attention model, and a result generated by the first cross-attention model is input into the second cross-attention model for performing the attention operation for the second time. Finally, a result generated by the second cross-attention model is the generated image GI.

It should be noted that the diffusion model DM may perform a plurality of times of diffusion operations. For example, a result generated by inputting the noise image NI into the diffusion model DM by the processor 11 to perform a diffusion operation for a first time may be input into the diffusion model DM again to perform the diffusion operation for the second time. The number of times of diffusion operation performed by the diffusion model DM is determined based on actual needs of the image augmentation device 1.

Specifically, the processor 11 generates a plurality of attention matrices AM corresponding to the semantic categories based on the noise image NI and the text vector TV. Then, the processor generates a plurality of mask attention matrices MAM corresponding to the semantic categories based on the semantic ranges corresponding to the semantic categories. Finally, the processor 11 generates the generated image GI based on the mask attention matrices MAM and the text vector TV.

In some embodiments, the attention matrices AM include at least a first attention matrix and a second attention matrix, the semantic categories include at least a first semantic category and a second semantic category, and the semantic ranges include at least a first semantic range and a second semantic range.

In some embodiments, each semantic category corresponds to a semantic range and an attention matrix. First, the processor 11 performs a mask operation on the first attention matrix based on the first semantic range corresponding to the first semantic category to generate a first mask attention matrix. Then, the processor 11 also performs the mask operation on the second attention matrix based on the second semantic range corresponding to the second semantic category to generate a second mask attention matrix.

It should be noted that the mask operation may be performed on data based on a mask, the mask is a matrix, and the dimension of the matrix is consistent with the dimension of data to be processed (for example, both are 256*256 two-dimensional matrices). A value in the mask may be either 0 or 1. During the operation on the data, an area with the value of 1 in the mask is retained, and an area with the value of 0 is discarded. In addition, pixel ranges described in the image for each of the semantic ranges corresponding to the semantic categories are not repeated.

Specifically, the processor 11 performs a mask operation on the first attention matrix based on the first semantic range corresponding to the first semantic category to generate a first mask attention matrix. Then, the processor 11 performs the mask operation on the second attention matrix based on the second semantic range corresponding to the second semantic category to generate a second mask attention matrix.

In the foregoing embodiments, the attention operation is performed based on the semantic information SI used as an attention constraint, so that the diffusion model DM focuses on augmentation of image content in different semantic ranges. In view of this, in the foregoing embodiments, the accuracy of the generated image GI generated by the diffusion model DM is further improved.

In the first embodiment, for ease of understanding, refer to a schematic diagram 200 of an image augmentation process in FIG. 2. As shown in the schematic diagram 200 of an image augmentation process, the processor 11 composites the generated image GI and a plurality of guide images P to generate an augmented image AI with richer textures. The guide images P are generated by segmenting the original image OI based on the semantic ranges.

It should be noted that when various artificial intelligence models (for example, image recognition models, image detection models, and image semantic segmentation models) are trained, if the amount of training data is excessively small or content of the training data is not rich enough, the image augmentation device 1 may be used to augment the training data. Using the augmented training data to train the artificial intelligence models may improve the versatility and accuracy of the artificial intelligence models.

Specifically, the processor 11 composites the generated image GI and a plurality of guide images P to generate an augmented image AI, wherein the guide images P are generated by segmenting the original image OI based on the semantic ranges.

In some embodiments, the text vector TV is generated by the processor 11 performing a coding operation on a text, and the coding operation may be performed by a text encoder (for example, a model that may convert a text into vectors, such as Word2vec, GloVe, or BERT). It should be noted that the text encoder may be hardware included in the image augmentation device 1, or may be software stored in the storage 12.

In addition, content described by the text is used to indicate the semantic categories. For example, the semantic categories corresponding to the original image OI include a vehicle, a road, and a sky, and the content of the text may be “vehicle, road, and sky” to indicate the semantic categories. It should be noted that the content of the text may be obtained by the processor 11 from a semantic category in the semantic information SI.

Specifically, the processor 11 performs a coding operation on a text to generate the text vector TV, wherein the text is used to indicate the semantic categories.

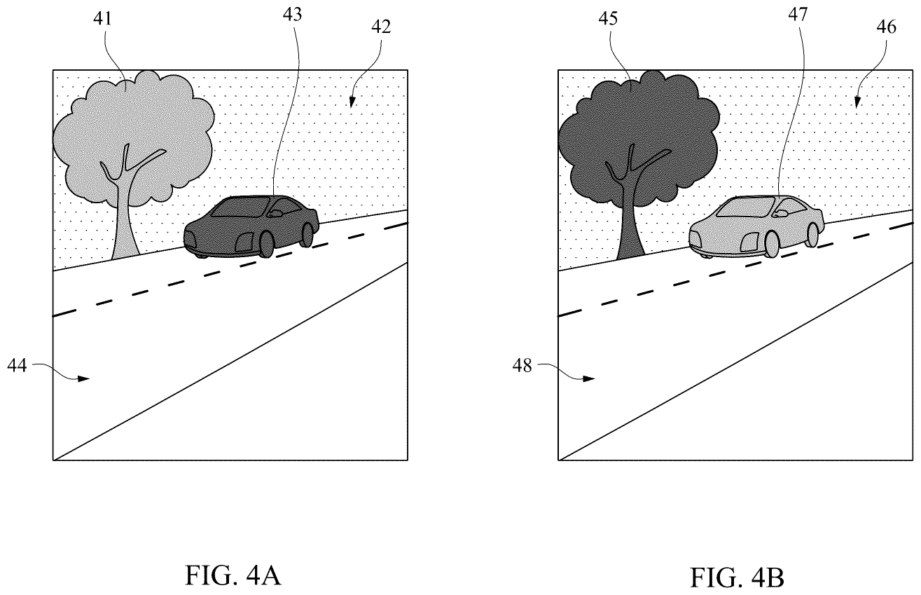

In some embodiments, in the image augmentation device 1, the text is further used to indicate an augmentation type corresponding to each of the semantic categories. For ease of understanding, refer to FIG. 4A and FIG. 4B. FIG. 4A is a schematic diagram of an original image, and FIG. 4B is a schematic diagram of a generated image corresponding to FIG. 4A. In other words, FIG. 4B is generated based on FIG. 4A. Objects 41, 42, 43, and 44 correspond to semantic categories of “tree”, “background”, “vehicle”, and “road”, respectively, and objects 45, 46, 47, and 48 correspond to semantic categories of “tree”, “background”, “vehicle”, and “road”, respectively.

As shown in FIG. 4A, the tree of the object 41 is light-colored, and the vehicle of the object 47 is dark-colored. For example, the text may be “dark-colored tree and light-colored vehicle”, augmentation types corresponding to each of the semantic categories are “dark-colored” and “light-colored”, respectively, and the foregoing augmentation types indicate descriptions about the colors of objects corresponding to the semantic categories.

Then, the color of the tree of the object 45 changes from the color of the tree of the object 41 to “dark-colored”, and the color of the vehicle of the object 47 changes from the color of the vehicle of the object 43 to “light-colored”.

For another example, the text may be “a sky full of dark clouds and a road with puddles”, augmentation types corresponding to each of the semantic categories are “full of dark clouds” and “with puddles”, respectively. The foregoing augmentation types indicate descriptions that objects corresponding to the semantic categories have more different objects generated due to the weather.

It should be noted that the image augmentation device 1 may further include a transceiver interface, and the transceiver interface is used to receive the text. The text can be generated by user input or by a generative language model.

Specifically, in the image augmentation device 1, the text is further used to indicate an augmentation type corresponding to each of the semantic categories.

In some embodiments, the semantic information SI include a plurality of semantic categories and a plurality of semantic ranges corresponding to the semantic categories, the semantic categories include at least a first semantic category and a second semantic category, and the semantic ranges include at least a first semantic range and a second semantic range.

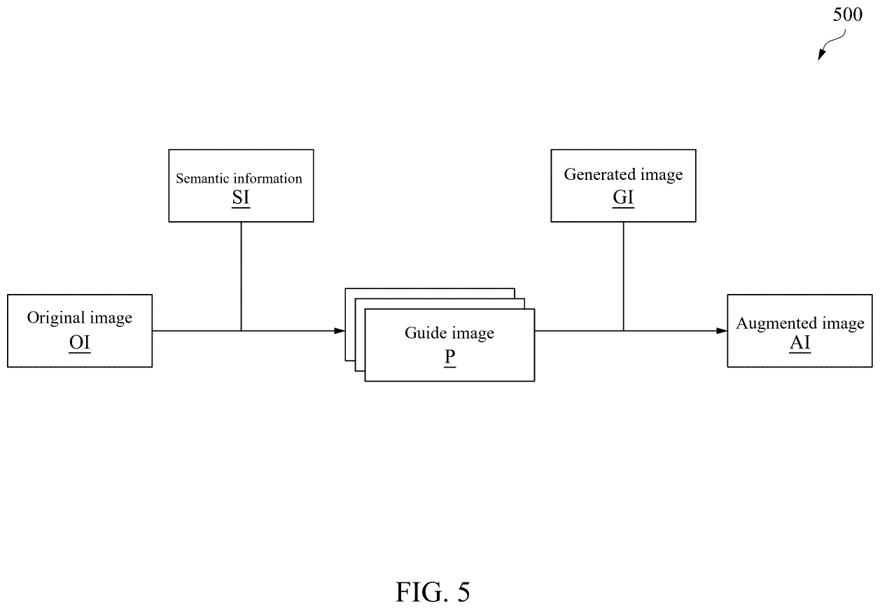

For ease of understanding, refer to a schematic diagram 500 of a guided filtering process in FIG. 5. In the schematic diagram 500 of a guided filtering process, the guide images P are generated by segmenting the original image OI based on the semantic ranges in the semantic information SI, the guide images P correspond to the semantic categories, and the guide images P include at least a first guide image and a second guide image.

First, the processor 11 segments, based on a first semantic range corresponding to a first semantic category, the first guide image corresponding to the first semantic category from the original image OI. Then, the processor 11 segments, based on a second semantic range corresponding to a second semantic category, the second guide image corresponding to the second semantic category from the original image OI.

It should be noted that the semantic ranges (including at least the first semantic range and the second semantic range) are used to represent pixel ranges of different objects corresponding to each of the semantic categories in the original image OI. Each of the semantic ranges may be a matrix, and the dimension of the matrix is the same as the dimension of the original image OI (for example, both are 256*256 two-dimensional matrices).

For example, the first semantic category is a vehicle, and the second semantic category is a road. The processor 11 may segment, from the original image OI, a first guide image corresponding to the vehicle and a second guide image corresponding to the road based on the first semantic range and the second semantic range through a mask operation.

An area in the first guide image corresponding to the vehicle that belongs to the first semantic range includes pixel values that are the same as those of an area in the original image OI that belongs to the first semantic range, and an area in the first guide image corresponding to the vehicle category that does not belong to the first semantic range includes pixel values that are all 0. In other words, in the first guide image, only the area belonging to the first semantic range displays pixel values, the pixel values are pixel values belonging to the category of the vehicle in the original image OI, and the pixel values of the area not belonging to the first semantic range are all 0.

Specifically, the processor 11 segments, based on a first semantic range corresponding to a first semantic category, the first guide image corresponding to the first semantic category from the original image OI, wherein the first semantic category is one of the semantic categories, and the first semantic range is one of the semantic ranges. Then, the processor 11 segments, based on a second semantic range corresponding to a second semantic category, the second guide image corresponding to the second semantic category from the original image OI, wherein the second semantic category is one of the semantic categories, and the second semantic range is one of the semantic ranges.

In some embodiments, the processor 11 composites the generated image GI and the guide images P to generate the augmented image AI, wherein the guide images P include at least a first guide image and a second guide image. For ease of understanding, refer to a schematic diagram 500 of a guided filtering process in FIG. 5.

As shown in the schematic diagram 500 of a guided filtering process, first, the processor 11 composites the generated image GI and the first guide image based on a guided filter and the first semantic range to generate a first augmented image. Then, the processor 11 composites the generated image GI and the second guide image based on the guided filter and the second semantic range to generate a second augmented image.

In some embodiments, an operation of compositing the generated image GI and the first guide image or the second guide image may be implemented by executing a guided filtering algorithm based on a guided filter.

For example, the guided filtering algorithm may be implemented by the following formula:

mean_{I}=fₘₑₐₙ(I)

meanₚ=fₘₑₐₙ(p)

corr_{I}=fₘₑₐₙ(I.*I)

corr_{Ip}=fₘₑₐₙ(I.*p)

In the foregoing formula, a parameter I represents an input image, a parameter p represents a guide image, a symbol fₘₑₐₙ represents a mean filter with a masking radius of r, a symbol mean represents a mean, and a symbol corr represents a correlation coefficient.

In some embodiments, I (input image) may first be combined with p (guide image) with a specific weight to generate a weighted fusion image (for example, I=(1−w)*/+w*p, where w is a weight value ranging from 0 to 1), and the weighted fusion image is used as an input image to perform a guided filtering algorithm.

Then, the guided filtering algorithm further includes the following formula:

var_{I}=corr_{I}−mean_{I}.*mean_{I}

cov_{Ip}=corr_{Ip}−mean_{I}.*meanₚ

In the foregoing formula, a symbol var represents variance, a symbol cov represents covariance. Then, the guided filtering algorithm further includes the following formula:

a=cov_{Ip}./(var_{I}+ϵ)

b=meanₚ−a.*mean_{I}

In the foregoing formula, a symbol e represents a regularization parameter epsilon, where e is used to avoid a situation in which the operation cannot be performed caused by the denominator of 0. A symbol a represents a liner coefficient, and a symbol b represents a constant term. Finally, the guided filtering algorithm further includes the following formula:

meanₐ=fₘₑₐₙ(a)

meanₚ=fₘₑₐₙ(b)

q=meanₐ.*I+mean_{b}

In the foregoing formula, a symbol q represents a generated output image.

In view of this, when the generated image GI and the first guide image are input into the guided filter to execute the guided filtering algorithm, only the area belonging to the first semantic range is composited to generate the first augmented image. Similarly, when the generated image GI and the second guide image are input into the guided filter to execute the guided filtering algorithm, only the area belonging to the second semantic range is composited to generate the second augmented image. In other words, a compositing operation of the generated image GI and the guide images P is a compositing operation performed in different semantic ranges, to generate partial augmented images belonging to each of the semantic ranges (that is, the first augmented image and the second augmented image).

Finally, the processor 11 combine the first augmented image and the second augmented image to generate the augmented image AI. It should be noted that a matrix of the first augmented image and a matrix of the second augmented image have the same dimension (for example, both are 256*256 two-dimensional matrices), therefore, the processor 11 may add the matrix of the first augmented image and the matrix of the second augmented image to combine the first augmented image and the second augmented image.

Specifically, the processor 11 composites the generated image GI and the first guide image based on a guided filter and the first semantic range to generate a first augmented image. Then, the processor 11 composites the generated image GI and the second guide image based on the guided filter and the second semantic range to generate a second augmented image. Finally, the processor 11 combine the first augmented image and the second augmented image to generate the augmented image AI.

In some embodiments, the processor 11 may calculate a first weight corresponding to the first augmented image and a second weight corresponding to the second augmented image, and multiply the first weight and the second weight by the first augmented image and the second augmented image respectively, to generate the augmented image AI.

For example, the first weight and the second weight may be randomly generated by the processor 11, where the first weight and the second weight range from 0.8 to 1.2. A first weight corresponding to the first augmented image is 1.1, and a second weight corresponding to the second augmented image is 0.9. The first weight is multiplied by the first augmented image, and the second weight is multiplied by the second augmented image, to generate the augmented image AI through compositing. Because the first weight is greater than the second weight, in the augmented image AI, content of the first augmented image is more obvious than content of the second augmented image. For another example, if the first weight is smaller than the second weight, in the augmented image AI, the content of the second augmented image is more obvious than the content of the first augmented image.

In the foregoing embodiments, the generated image GI and the guide images P are composited, so that the augmented image AI has richer color information and texture information, further improving the content richness of the augmented image AI. In addition, in the foregoing embodiments, the augmented image AI is generated based on the first weight and the second weight, so that the content richness of the augmented image AI is further improved.

Specifically, the processor 11 combines the first augmented image and the second augmented image based on a first weight corresponding to the first augmented image and a second weight corresponding to the second augmented image to generate the augmented image AI.

It may be learned from the foregoing content, the image augmentation device provided in the present disclosure inputs a noise image corresponding to an original image and semantic information and a text vector corresponding to the original image into a diffusion model to generate a generated image, wherein the generated image includes a partial contour of the original image. Then, in the present disclosure, the generated image and a plurality of guide images are composited to generate an augmented image. Because the semantic information is used as the attention constraint in the diffusion model in the present disclosure, the technologies provided in the present disclosure can accurately augment content corresponding to different semantic categories in an image.

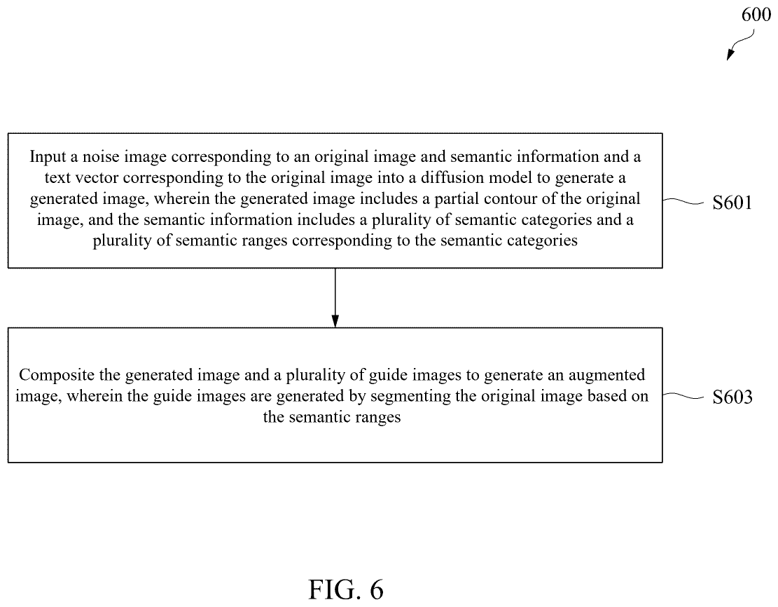

A second embodiment of the present disclosure is an image augmentation method, and a schematic diagram thereof is FIG. 6. The image augmentation method 600 is applied to an electronic device, for example, the image augmentation device in the first embodiment. The electronic device is configured to store a diffusion model. In the image augmentation method 600, image augmentation is performed through step S601 and step S603.

First, in step S601, the electronic device inputs a noise image corresponding to an original image and semantic information and a text vector corresponding to the original image into the diffusion model to generate a generated image, wherein the generated image includes a partial contour of the original image, and the semantic information includes a plurality of semantic categories and a plurality of semantic ranges corresponding to the semantic categories.

Then, in step S603, the electronic device composites the generated image and a plurality of guide images to generate an augmented image, wherein the guide images are generated by segmenting the original image based on the semantic ranges.

In some embodiments, the noise image corresponding to the original image is generated based on the following step: performing a noise addition operation on the original image to generate the noise image corresponding to the original image.

In some embodiments, the text vector is generated based on the following step: performing a coding operation on a text to generate the text vector, wherein the text is used to indicate the semantic categories.

In some embodiments, the text is further used to indicate an augmentation type corresponding to each of the semantic categories.

In some embodiments, a step of inputting the noise image, the semantic information, and the text vector corresponding to the original image into the diffusion model to generate the generated image further includes the following steps: generating a plurality of attention matrices corresponding to the semantic categories based on the semantic information and the text vector; generating a plurality of mask attention matrices corresponding to the semantic categories based on the semantic ranges corresponding to the semantic categories; and generating the generated image based on the mask attention matrices and the text vector.

In some embodiments, the image augmentation method 600 further includes the following steps: performing a mask operation on the first attention matrix based on the first semantic range corresponding to the first semantic category to generate a first mask attention matrix; and performing the mask operation on the second attention matrix based on the second semantic range corresponding to the second semantic category to generate a second mask attention matrix.

In some embodiments, the guide images include at least a first guide image and a second guide image, and the first guide image and the second guide image are generated based on the following steps: segmenting, based on a first semantic range corresponding to a first semantic category, the first guide image corresponding to the first semantic category from the original image, wherein the first semantic category is one of the semantic categories, and the first semantic range is one of the semantic ranges; and segmenting, based on a second semantic range corresponding to a second semantic category, the second guide image corresponding to the second semantic category from the original image, wherein the second semantic category is one of the semantic categories, and the second semantic range is one of the semantic ranges.

In some embodiments, a step of compositing the generated image and the guide images to generate the augmented image further includes the following steps: compositing the generated image and the first guide image based on a guided filter and the first semantic range to generate a first augmented image; compositing the generated image and the second guide image based on the guided filter and the second semantic range to generate a second augmented image; and combining the first augmented image and the second augmented image to generate the augmented image.

In some embodiments, a step of combining the first augmented image and the second augmented image to generate the augmented image further includes the following step: combining the first augmented image and the second augmented image based on a first weight corresponding to the first augmented image and a second weight corresponding to the second augmented image to generate the augmented image.

In addition to the foregoing steps, in the second embodiment, all operations and steps of the image augmentation device 1 described in the first embodiment can also be performed, there are the same functions, and the same technical effects are achieved. Persons having ordinary skill in the art to which the present disclosure belongs may directly understand how to perform these operations and steps in the second embodiment based on the foregoing first embodiment, there are the same functions, and the same technical effects are achieved. Details are not described herein again.

It should be noted that in the patent specification and claims of the present disclosure, some terms (including an attention matrix, a mask attention matrix, a semantic category, a semantic range, a guide image, an augmented image, and the like) are preceded by “first” or “second”, and such “first” or “second” is only used to distinguish different terms. For example, the “first” and “second” in the first attention matrix and the second attention matrix are only used to indicate that the first attention matrix and the second attention matrix correspond to different semantic categories in the operation.

In conclusion, according to the technologies (including at least the image augmentation device and method) provided in the present disclosure, a noise image corresponding to an original image and semantic information and a text vector corresponding to the original image are input into a diffusion model to generate a generated image, wherein the generated image includes a partial contour of the original image. Then, in the present disclosure, the generated image and a plurality of guide images are composited to generate an augmented image. Because the semantic information is used as the attention constraint in the diffusion model in the present disclosure, the technologies provided in the present disclosure can accurately augment content corresponding to different semantic categories in an image.

The foregoing embodiments are only used to exemplify some embodiments of the present disclosure and to explain the technical features of the present disclosure, but are not used to limit the scope and range of protection of the present disclosure. Any changes or equivalent arrangements that may be easily accomplished by persons having ordinary skill in the art to which the present disclosure belongs are within the scope claimed by the present disclosure, and the scope of protection of the present disclosure shall be based on the scope of the patent application.

What is claimed is:

1. An image augmentation device, comprising:
a storage, configured to store a diffusion model; and
a processor, electrically connected to the storage and performing the following operations:
inputting a noise image corresponding to an original image and semantic information and a text vector corresponding to the original image into the diffusion model to generate a generated image, wherein the generated image comprises a partial contour of the original image, and the semantic information comprises a plurality of semantic categories and a plurality of semantic ranges corresponding to the semantic categories; and
compositing the generated image and a plurality of guide images to generate an augmented image, wherein the guide images are generated by segmenting the original image based on the semantic ranges.

2. The image augmentation device according to claim 1, wherein the noise image corresponding to the original image is generated based on the following operation:
performing a noise addition operation on the original image to generate the noise image corresponding to the original image.

3. The image augmentation device according to claim 1, wherein the text vector is generated based on the following operation:
performing a coding operation on a text to generate the text vector, wherein the text is used to indicate the semantic categories.

4. The image augmentation device according to claim 3, wherein the text is further used to indicate an augmentation type corresponding to each of the semantic categories.

5. The image augmentation device according to claim 1, wherein an operation of inputting the noise image, the semantic information, and the text vector corresponding to the original image into the diffusion model to generate the generated image further comprises the following operations:
generating a plurality of attention matrices corresponding to the semantic categories based on the noise image and the text vector;
generating a plurality of mask attention matrices corresponding to the semantic categories based on the semantic ranges corresponding to the semantic categories; and
generating the generated image based on the mask attention matrices and the text vector.

6. The image augmentation device according to claim 5, wherein the attention matrices comprise at least a first attention matrix and a second attention matrix, the semantic categories comprise at least a first semantic category and a second semantic category, and the semantic ranges comprise at least a first semantic range and a second semantic range.

7. The image augmentation device according to claim 6, wherein the processor further performs the following operations:
performing a mask operation on the first attention matrix based on the first semantic range corresponding to the first semantic category to generate a first mask attention matrix; and
performing the mask operation on the second attention matrix based on the second semantic range corresponding to the second semantic category to generate a second mask attention matrix.

8. The image augmentation device according to claim 1, wherein the guide images comprise at least a first guide image and a second guide image, and the first guide image and the second guide image are generated based on the following operations:
segmenting, based on a first semantic range corresponding to a first semantic category, the first guide image corresponding to the first semantic category from the original image, wherein the first semantic category is one of the semantic categories, and the first semantic range is one of the semantic ranges; and
segmenting, based on a second semantic range corresponding to a second semantic category, the second guide image corresponding to the second semantic category from the original image, wherein the second semantic category is one of the semantic categories, and the second semantic range is one of the semantic ranges.

9. The image augmentation device according to claim 8, wherein an operation of compositing the generated image and the guide images to generate the augmented image further comprises the following operations:
compositing the generated image and the first guide image based on a guided filter and the first semantic range to generate a first augmented image;
compositing the generated image and the second guide image based on the guided filter and the second semantic range to generate a second augmented image; and
combining the first augmented image and the second augmented image to generate the augmented image.

10. The image augmentation device according to claim 9, wherein an operation of combining the first augmented image and the second augmented image to generate the augmented image further comprises the following operation:
combining the first augmented image and the second augmented image based on a first weight corresponding to the first augmented image and a second weight corresponding to the second augmented image to generate the augmented image.

11. An image augmentation method, applied to an electronic device, wherein the electronic device comprises a storage and a processor, the storage is configured to store a diffusion model, and the image augmentation method comprises the following steps:
inputting a noise image corresponding to an original image and semantic information and a text vector corresponding to the original image into the diffusion model to generate a generated image, wherein the generated image comprises a partial contour of the original image, and the semantic information comprises a plurality of semantic categories and a plurality of semantic ranges corresponding to the semantic categories; and
compositing the generated image and a plurality of guide images to generate an augmented image, wherein the guide images are generated by segmenting the original image based on the semantic ranges.

12. The image augmentation method according to claim 11, wherein the noise image corresponding to the original image is generated based on the following step:
performing a noise addition operation on the original image to generate the noise image corresponding to the original image.

13. The image augmentation method according to claim 11, wherein the text vector is generated based on the following step:
performing a coding operation on a text to generate the text vector, wherein the text is used to indicate the semantic categories.

14. The image augmentation method according to claim 13, wherein the text is further used to indicate an augmentation type corresponding to each of the semantic categories.

15. The image augmentation method according to claim 11, wherein a step of inputting the noise image, the semantic information, and the text vector corresponding to the original image into the diffusion model to generate the generated image further comprises the following steps:
generating a plurality of attention matrices corresponding to the semantic categories based on the noise image and the text vector;
generating a plurality of mask attention matrices corresponding to the semantic categories based on the semantic ranges corresponding to the semantic categories; and
generating the generated image based on the mask attention matrices and the text vector.

16. The image augmentation method according to claim 15, wherein the attention matrices comprise at least a first attention matrix and a second attention matrix, the semantic categories comprise at least a first semantic category and a second semantic category, and the semantic ranges comprise at least a first semantic range and a second semantic range.

17. The image augmentation method according to claim 16, further comprising the following steps:
performing a mask operation on the first attention matrix based on the first semantic range corresponding to the first semantic category to generate a first mask attention matrix; and
performing the mask operation on the second attention matrix based on the second semantic range corresponding to the second semantic category to generate a second mask attention matrix.

18. The image augmentation method according to claim 11, wherein the guide images comprise at least a first guide image and a second guide image, and the first guide image and the second guide image are generated based on the following steps:
segmenting, based on a first semantic range corresponding to a first semantic category, the first guide image corresponding to the first semantic category from the original image, wherein the first semantic category is one of the semantic categories, and the first semantic range is one of the semantic ranges; and
segmenting, based on a second semantic range corresponding to a second semantic category, the second guide image corresponding to the second semantic category from the original image, wherein the second semantic category is one of the semantic categories, and the second semantic range is one of the semantic ranges.

19. The image augmentation method according to claim 18, wherein a step of compositing the generated image and the guide images to generate the augmented image further comprises the following steps:
compositing the generated image and the first guide image based on a guided filter and the first semantic range to generate a first augmented image;
compositing the generated image and the second guide image based on the guided filter and the second semantic range to generate a second augmented image; and
combining the first augmented image and the second augmented image to generate the augmented image.

20. The image augmentation method according to claim 19, wherein a step of combining the first augmented image and the second augmented image to generate the augmented image further comprises the following step:
combining the first augmented image and the second augmented image based on a first weight corresponding to the first augmented image and a second weight corresponding to the second augmented image to generate the augmented image.
